(19) United States
(12) Patent Application Publication
(10) Pub. No.: US 2005/0125514 A1
(43) Pub. Date: Jun. 9, 2005

(54) Dynamic resource allocation systems and methods

(75) Inventor: Vinod K. Balakrishnan, Beaverton, OR (US)

Correspondence Address: JUNG-HUA KUO;C/O PORTFOLIOIP, P. O. BOX 52050, MINNEAPOLIS, MN, 55402, US

(73) Assignee: Intel Corporation, A DELAWARE CORPORATION, Santa Clara, CA (US)

(21) Appl. No.: 10/719,469

(22) Filed: Nov. 21, 2003

(51) Int. Cl. G06F 15/177; H04L 12/28; H04L 12/56

(52) U.S. Cl. 709/221; 370/389

(57) ABSTRACT

Systems and methods are disclosed for facilitating dynamic resource allocation in a limited memory environment. In one embodiment, a master code image is created that includes one or more alternative implementations of an interface. When it is determined that a particular implementation of the interface is desired, the alternative implementations are removed from the master code image, and the resulting code image is compiled. The program is then used to process network traffic. If a condition is subsequently detected that could be handled more efficiently by one of the alternative interface implementations, the process can be repeated, and the resulting program used to process further network traffic.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes a “payload” and a “header.” The packet's “payload” is analogous to the letter inside the envelope. The packet's “header” is much like the information written on the envelope itself. The header can include information to help network devices handle the packet appropriately. For example, the header can include an address that identifies the packet's destination.

A given packet may “hop” across many different intermediate network devices (e.g., “routers,” “bridges,” and “switches”) before reaching its destination. These intermediate devices often perform a variety of packet processing operations. For example, intermediate devices often perform address lookup and packet classification to determine how to forward a packet toward its destination, or to determine the quality of service to provide.

Network processors are used to process packets so that they can be used by higher-level applications. Network processors may be programmable, thereby enabling the same basic hardware to be used in a variety of different applications. Many network processors include multiple processors, or microengines, each with its own memory.

### BRIEF DESCRIPTION OF THE DRAWINGS

Reference will be made to the following drawings, in which:

FIG. 1 is a diagram of a network processor.

FIG. 2 illustrates a process for creating a code image that includes a specific instance of an interface.

FIG. 3 provides a more detailed illustration of a process such as that shown in FIG. 2.

FIG. 4 illustrates a method for performing dynamic resource allocation.

FIG. 5 is a diagram of a network device.

### DESCRIPTION OF SPECIFIC EMBODIMENTS

Systems and methods are disclosed for facilitating dynamic resource allocation in network processors and/or related devices. It should be appreciated that these systems and methods can be implemented in numerous ways, several examples of which are described below. The following description is presented to enable any person skilled in the art to make and use the inventive body of work. The general principles defined herein may be applied to other embodiments and applications. Descriptions of specific embodiments and applications are thus provided only as examples, and various modifications will be readily apparent to those skilled in the art. For example, although several examples are provided in the context of Intel® Internet Exchange network processors, it will be appreciated that the same principles can be readily applied to any suitable network processor or device. Accordingly, the following description is to be accorded the widest scope, encompassing numerous alternatives, modifications, and equivalents. For purposes of clarity, technical material that is known in the art has not been described in detail so as not to unnecessarily obscure the inventive body of work.

Network processors are typically used to perform packet processing and/or other networking operations. Some network processors—such as the Internet Exchange Architecture (1×A) network processors produced by Intel Corporation of Santa Clara, Calif.—are programmable, which enables the same network processor hardware to be used for a variety of applications, and also enables extension or modification of the network processor's functionality via new or modified programs.

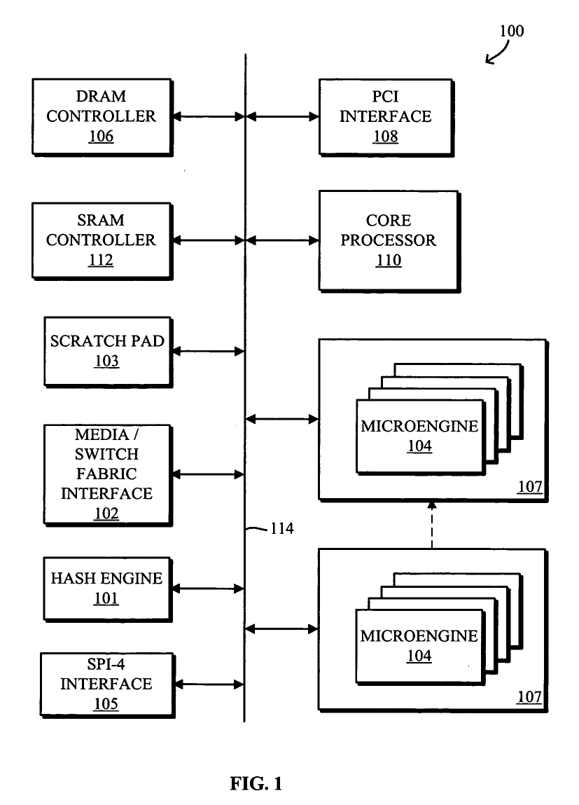

An example of a network processor 100 is shown in FIG. 1. The network processor 100 shown in FIG. 1 has a collection of microengines 104, arranged in clusters 107. Microengines 104 may, for example, comprise multi-threaded, Reduced Instruction Set Computing (RISC) processors tailored for packet processing. As shown in FIG. 1, network processor 100 may also include a core processor 110 (e.g., an Intel XScale® processor) that may be programmed to perform “control plane” tasks involved in network operations, such as signaling stacks and communicating with other processors. The core processor 110 may also handle some “data plane” tasks, and may provide additional packet processing threads.

Network processor 100 may also feature a variety of interfaces that carry packets between network processor 100 and other network components. For example, network processor 100 may include a switch fabric interface 102 (e.g., a Common Switch Interface (CSIX)) for transmitting packets to other processor(s) or circuitry connected to the fabric; an interface 105 (e.g., a System Packet Interface Level 4 (SPI-4) interface) that enables network processor 100 to communicate with physical layer and/or link layer devices; an interface 108 (e.g., a Peripheral Component Interconnect (PCI) bus interface) for communicating, for example, with a host; and/or the like. Network processor 100 may also include other components shared by the microengines, such as memory controllers 106, 112, a hash engine 101, and a scratch pad memory 103. One or more internal buses 114 are also provided to facilitate communication between the various components of the system.

It should be appreciated that FIG. 1 is provided for purposes of illustration, and not limitation, and that the systems and methods described herein can be practiced with devices and architectures that lack some of the components and features shown in FIG. 1 and/or that have other components or features that are not shown.

As previously indicated, microengines 104 may, for example, comprise multi-threaded RISC engines having self-contained instruction and data memory to enable rapid access to locally stored code and data. Microengines 104 may also include one or more hardware-based coprocessors for performing specialized functions such as serialization, cyclic redundancy checking (CRC), cryptography, High-Level Data Link (HDLC) bit stuffing, and/or the like. The multi-threading capability of the microengines 104 may be supported by hardware that reserves different registers for different threads and can quickly swap thread contexts. The microengines 104 may communicate with neighboring microengines 104 via, e.g., shared memory and/or neighbor registers that are wired to adjacent engine(s).

In programmable systems such as that described above, it can be useful to dynamically alter the allocation of resources to a particular task. In network processor systems, for example, such run-time adaptability can enable the network processor to more efficiently utilize its processing resources. An example of run-time adaptation in a network processor environment might be the decision to use two microengines instead of one for packet processing, based on an increase in input traffic. Another example might be the decision to implement a lock using either a general purpose register (GPR), as might be acceptable if the lock is shared only by threads within a single microengine, or using static random access memory (SRAM), as might be desired if the lock is shared between different microengines. The software developer may not know in advance whether the lock will be mapped onto one microengine or onto multiple microengines; this may not be known until runtime.

Run-time adaptability can be achieved in a variety of ways. For example, the code that detects the need to make a change can be compiled into the code image along with the code necessary to implement each possible behavior change (e.g., the code that implements the lock using SRAM, and the code that implements the lock using a register). Once the detection code determines that a change needs to be made, the code for the appropriate behavior can be selected. A problem with this approach, however, is that it can result in a relatively large code image, and since many network processors have a relatively limited code store (e.g., 4 kilobytes on an Intel IXP 2xxx microengine), it is generally desirable to implement the code that will run on such systems in a relatively compact manner.

Thus, in one embodiment run-time adaptation can be achieved by changing the instance of the code that implements the desired behavior. That is, instead of including code for each possible situation in the final executable, only the code for the behavior that is actually used is included (or only the code for some suitable subset of possible behaviors). For example, if each behavior is associated with an interface, each interface can be said to have multiple implementations or instances, only one (or some other subset) of which is included in the executable image that is run on the network processor's microengines. Adaptation involves changing the instance of the interface that is used in the executable code image.

One way to realize such an approach to resource adaptation is to implement each interface as a subroutine. The compiler generates code with unresolved branches (e.g., calls to the unknown interfaces). The linker then links in the particular instance for each interface and resolves the unresolved references. This approach will typically involve defining an application binary interface (ABI) to which the compiler and the instance code conform. There will generally be some overhead associated with such an approach, due to the subroutine call and return and due to the copies involved in conforming to the ABI (e.g., copying input arguments into reserved registers, copying out the output arguments, and so forth). In some embodiments, this copy and branching overhead may be disproportionate to the size of the code that actually implements the interface instance. For example, if the interface code is small (e.g., one or two lines), implementing it in a subroutine may incur branch and copy overhead that is larger than the instance code itself.

Thus, as described below, in other embodiments a more efficient method is provided for linking between the executable code image and the desired (i.e., selected) interface implementations. In one embodiment, a new language feature is used: a switch/case statement that is interpreted by the linker.

For example, consider an interface I that has n instances I₁, I₂ . . . Iₙ. The interface can be implemented in the form of a switch/case statement, with each instance being a different case.

switch (CASE)
{
case 1:

Implementation of I1;
break;

case 2:

Implementation of I2;
break;

. . . .
case n:

Implementation of In;
break;

}

In this code construct, the value of the CASE variable is used to select the particular interface implementation that is executed. For example, if the CASE variable is equal to “case 1,” then implementation I1 of the interface is selected. If the CASE variable is equal to “case 2,” then implementation I2 of the interface is selected, and so forth.

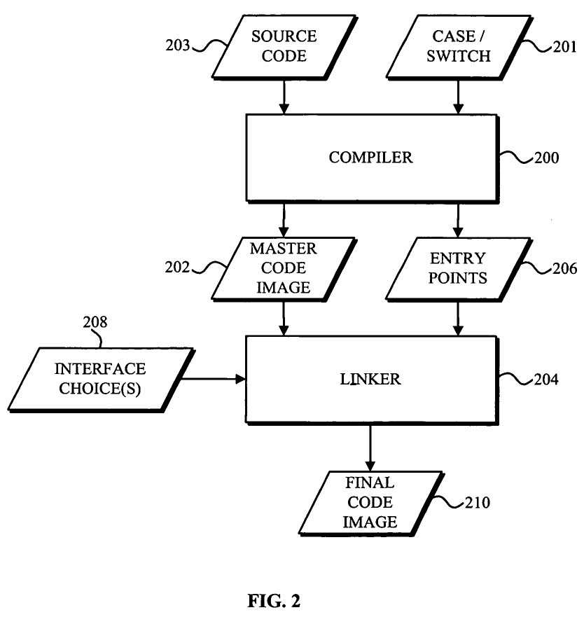

FIG. 2 shows an example embodiment of such a technique. As shown in FIG. 2, the compiler 200 may receive as inputs the case/switch statement 201 and the source code 203. The compiler 200 may simply inline the switch/case statement 201 into the compiled code image 202 (e.g., insert it directly, or with minor modification). If multiple switch/case statements are inserted (e.g., for multiple interfaces), the compiler 200 may also generate a list of entry points 206 indicating the locations of these switch/case statements in the code image 202. The linker 204 resolves the value of the CASE variable(s) (either directly, or after receiving the value or related data 208 from another code module), interprets the switch statement(s), and removes instances of the code that are not required from the final executable code image 210. For example, if it were determined that instance I1 is to be used, the linker would remove the other instances of code and the switch statement itself. By inlining the interface instances, the branch and return penalty associated with subroutines can be avoided. In addition, the size of the final code image 210 is minimized, since the linker removes instances that are not required.

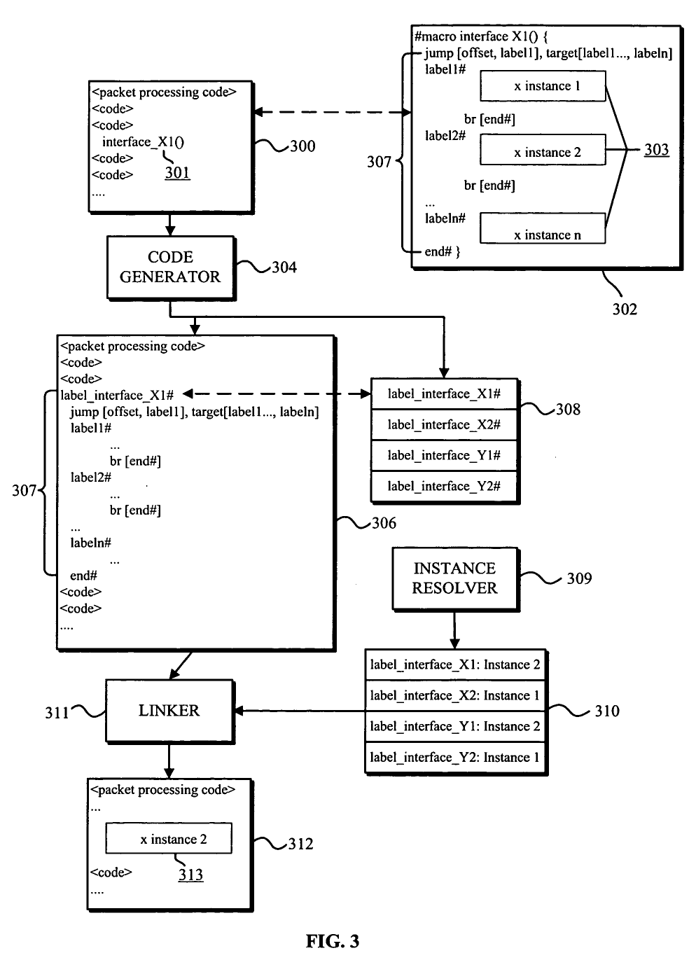

A more detailed illustration is shown in FIG. 3. Referring to FIG. 3, different interfaces can be implemented as macros 302 containing a switch/case statement 307, where each case corresponds to a different instance 303 of the interface. For example, as shown in FIG. 3, “interface X1” 301 may have n alternative implementations (i.e., instances 303). The code for each alternative implementation is included in switch statement 307 in macro 302.

In the example shown in FIG. 3, the code generator (or compiler) 304 has a preprocessor stage that processes macro 302 (and any other macros for other interfaces (not shown)), and inlines it so that it appears in the compiler's object code output or image (file) 306. The code generator 304 may also generate a list of labels 308 corresponding to the entry points (or locations) of the different interfaces, along with the interface names. For example, as shown in FIG. 3, the object file may contain more than one interface (i.e., interfaces X1, X2, Y1, and Y2), each having a number of alternative implementations that are inserted into the object code image 306 via macros similar to macro 302. The list of labels 308, indicates where each such interface is located in object file 306.

Referring once again to FIG. 3, the instance resolver 309 monitors system performance and decides which instance to use for each interface. The resulting mapping 310 between interfaces and instances, along with the object file 306 from the code generator 304, are provided as input to the linker 311. The linker 311 interprets the switch statement for each interface, and, using the mapping from the instance resolver 309, removes the instances that are not required as well as the switch statements themselves (e.g., the initial jump/branch instruction, the various labels, etc.) to form an executable program or code image 312 that contains the desired instances for each interface. For example, as shown in FIG. 3, instance resolver 309 determines that interface X1 should be implemented using “instance 2.” The resolver also determines the appropriate instances to use for each of the other interfaces (e.g., it determines that interface X2 should be implemented using instance 1 from its set of alternative implementations, etc.). Based on this mapping 310, the linker 311 removes the other possible implementations of each interface from the object code 306, leaving the selected instances 313 in the final code image 312.

Referring to FIG. 3, the original source code 300 is typically compiled on the software developer's system—for example, a personal computer or workstation that is separate from the network processor. Such a system will typically not be memory constrained. A copy of the compiled object code 306 and the list of labels 308 may then be loaded onto a network processor (e.g., into memory accessible to the network processor's core processor). On the network processor, the linker and the instance resolver will typically be stored in memory accessible to the core processor, and the core processor will execute the linker and the instance resolver to perform the actions described herein. For example, the instance resolver can be configured to monitor system performance (e.g., queue depth, throughput, etc.), and determine whether a behavior or instance change is desirable. If a change is desirable, then the core processor executes the linker to generate a new code image that includes the desired interface instances, and causes the new code image to be loaded onto the relevant microengines (where instruction memory might be somewhat constrained) so that it can be used for further processing. The master code image 306 preferably remains stored on (or accessible to) the network processor core, so that the process of generating new code images can be repeated each time the resolver determines that additional changes should be made. The linker 311 can be created by modifying a conventional linker (which is typically used to insert code and/or data into compiled object code to produce a binary code image) to also include the ability to identify the switch statements indicated by the resolver and to remove the unwanted interface instances.

It will be appreciated that numerous modifications can be made to the example shown in FIG. 3. For example, in some embodiments the code developer may choose to inline the different interface implementations 303 directly into the source code 300, rather than using a macro 302. Another alternative would be to place the interface implementations in a separate library that is called by the source code. In addition, it will be appreciated that code constructs other than case/switch statements can be used to organize the different interface instances in the object code image 306. The linker (or other tool) simply parses the particular code construct to identify the desired instance(s), so that it can remove the unwanted instances (and preferably the code construct itself) when forming the final executable (or interpretable) image 312. For example, as previously indicated, the object code image might contain an unresolved subroutine call, which the linker could replace with the desired interface instance, thereby avoiding the branching and copy overhead associated with a subroutine call. Yet another modification might be to run the compiler itself on the network processor, using it to perform some or all of the inlining, resolving, and code removal, without assistance from a linker. Thus it should be appreciated that the example shown in FIG. 3 is provided for purposes of illustration, and that in other embodiments, other system configurations and techniques can be used.

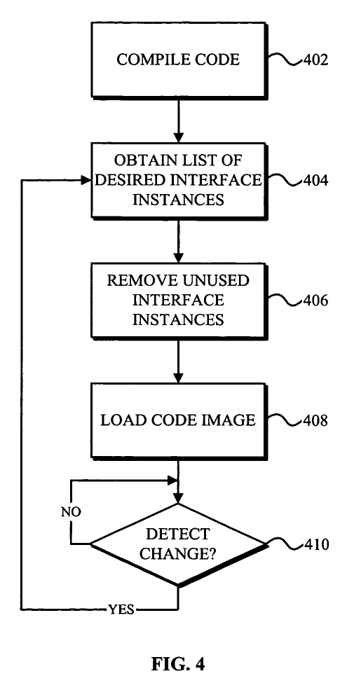

FIG. 4 illustrates a process for achieving run-time adaptability such as that described above. Referring to FIG. 4, a code image is compiled containing multiple instances of one or more interfaces (block 402). A selection is made of the particular interfaces that are to be used (block 404), and a linker or other tool removes the other instances (block 406). The resulting code image is then loaded and used to process network traffic (block 408). Subsequently, when a determination is made to change the behavior of one or more interfaces (i.e., a “Yes” exit from block 410), the code that implements the desired behavior is linked into a new code image, and the code that implements other behaviors is removed (blocks 404, 406). The previous code image is replaced by the new code image, which is then used to process network traffic (block 408). By providing an efficient mechanism for performing run-time adaptation, embodiments such as those described above can be used to further enhance the capabilities and desirability of programmable network processors over purely application-specific integrated circuit (ASIC) approaches.

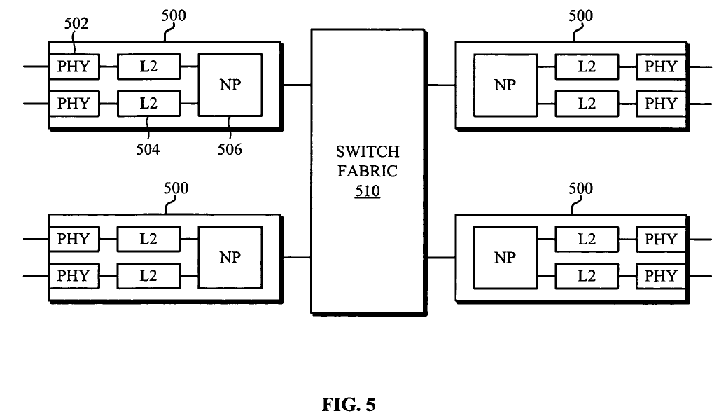

The techniques described above may be used by a variety of network systems. For example, the techniques described above may be implemented in a programmable network processor, such as that shown in FIG. 1, which can, in turn, form part of a larger system (e.g., a network device). FIG. 5 shows an example of such a system. As shown in FIG. 5, the system features a collection of line cards or “blades” 500 interconnected by a switch fabric 510 (e.g., a crossbar or shared memory switch fabric). The switch fabric 510 may, for example, conform to the Common Switch Interface (CSIX) or other fabric technologies such as HyperTransport, Infiniband, PCI-X, Packet-Over-SONET, RapidIO, and Utopia.

Individual line cards 500 may include one or more physical layer (PHY) devices 502 (e.g., optical, wire, and/or wireless) that handle communication over network connections. The physical layer devices 502 translate the physical signals carried by different network mediums into the bits (e.g., 1s and 0s) used by digital systems. The line cards 500 may also include framer devices 504 (e.g., Ethernet, Synchronous Optic Network (SONET), High-Level Data Link (HDLC) framers, and/or other “layer 2” devices) that can perform operations on frames such as error detection and/or correction. The line cards 500 may also include one or more network processors 506 (such as network processor 100 shown in FIG. 1) to, e.g., perform packet processing operations on packets received via the physical layer devices 502.

While FIGS. 1 and 5 illustrate a network processor and a device incorporating one or more network processors, it will be appreciated that the systems and methods described herein can be implemented using other hardware, firmware, and/or software. In addition, the techniques described herein may be applied in a wide variety of network devices (e.g., routers, switches, bridges, hubs, traffic generators, and/or the like).

The term packet has, at times, been used in the above description to refer to an IP packet encapsulating a TCP segment. However, a packet may also, or alternatively, be a frame, a fragment, an ATM cell, and so forth, depending on the network technology being used. In addition, while reference has been made to the implementation and use of various “interfaces,” it should be appreciated that this term is used herein to refer broadly to any suitable behavior, variable, procedure, or the like, and is not strictly limited to code that implements a boundary between two different systems or modules.

Thus, while several embodiments are described and illustrated herein, it will be appreciated that they are merely illustrative. Other embodiments are within the scope of the following claims.

1. A method comprising:
processing network traffic using a first program, the first program containing a first interface instance having a first behavior;
detecting a first condition;
generating a second program, the second program containing a second interface instance having a second behavior, the generation of the second program including selecting the second interface instance from a plurality of interface instances for inclusion in the second program; and
processing network traffic using the second program.

2. The method of claim 1, in which the second interface instance is inlined into the second program, such that it is reachable without executing a jump or branch instruction.

3. The method of claim 1, in which generating the second program comprises:
interpreting a switch statement in a master program to locate the second interface instance; and
removing one or more interface instances other than the second interface instance from the master program.

4. The method of claim 3, in which the one or more interface instances other than the second interface instance includes the first interface instance.

5. The method of claim 3, in which the generation of the second program is performed by a linker.

6. The method of claim 1, further comprising replacing the first program with the second program in at least one microengine, wherein the processing of network traffic using the first and second programs is performed by said at least one microengine.

7. The method of claim 1, in which the first condition comprises a change in network traffic.

8. The method of claim 1, further comprising:
detecting a second condition;
generating a third program, the third program containing a third interface instance having a third behavior, the generation of the third program including selecting the third interface instance from a plurality of interface instances for inclusion in the third program; and
processing network traffic using the third program.

9. The method of claim 8, in which the third program includes the second interface instance, the second interface instance corresponding to a different interface from the third interface instance.

10. The method of claim 1, in which generating the second program comprises replacing a subroutine call in a copy of a master program with the second interface instance.

11. The method of claim 1, in which generating the second program comprises removing code from a third program.

12. The method of claim 11, in which the second program is smaller than the third program.

13. The method of claim 1, in which the first program and the second program comprise different versions of the same program.

14. The method of claim 1, in which the first program and the second program are written in an instruction set of a microengine that performs the processing of network traffic using the first and second programs.

15. A computer program package embodied on a computer readable medium, the computer program package including instructions that, when executed by a processor, cause the processor to perform actions comprising:
obtaining an identification of a selected implementation of a first interface;
obtaining a first code image containing the selected implementation of the first interface and one or more other implementations of the first interface;
generating a second code image by removing the one or more other implementations of the first interface from the first code image.

16. The computer program package of claim 15, in which the selected implementation of the first interface and the one or more other implementations of the first interface are located in a switch statement in the first code image.

17. The computer program package of claim 15, in which the computer readable medium comprises a memory unit associated with a network processor, and in which the processor comprises a core processor of said network processor.

18. A system comprising:
a network processor comprising:
a processing core;
one or more microengines; and
a memory unit, the memory unit including code that, when executed by the processing core, is operable to cause the network processor to perform actions comprising:
detecting a first condition;
identifying a first instance of a first interface suitable for handling the first condition;
selecting the first instance of the first interface from a plurality of instances of the first interface;
generating a code image that includes the first instance of the first interface; and
loading the code image into one or more of the microengines for execution.

19. The system of claim 18, in which the plurality of instances of the first interface are arranged within a switch statement in a master code image stored in memory accessible by said processing core.

20. A system as in claim 18, in which the memory unit further includes a linker, the linker being operable to interpret a switch statement and to remove unselected instances of an interface from the switch statement.

21. A system as in claim 18, in which the memory unit further includes an instance resolver, the instance resolver including the code for detecting a first condition and identifying a first instance of a first interface suitable for handling the first condition.

22. The system of claim 18, further comprising:
a computer system to enable development of software for use on the network processor, the computer system including:
a compiler operable to compile a source code program into an object code program, the compiler being operable to inline said plurality of instances of the first interface into the object code program.

23. A method for performing dynamic resource adaptation, the method comprising:
identifying a selected interface implementation;
removing one or more other interface implementations from a first code image to form a second code image that includes the selected interface implementation;
using the second code image to perform one or more network processing tasks.

24. The method of claim 23, in which the first code image contains a switch statement that includes the selected interface implementation and the one or more other interface implementations, the method further comprising:
removing the switch statement from the first code image.

25. The method of claim 23, in which removing of the one or more other interface implementations is performed by a linker.

26. A system comprising:
a switch fabric; and
one or more line cards comprising:
one or more physical layer components; and
one or more network processors, at least one of said network processors comprising:
a processing core;
one or more microengines; and
a memory unit, the memory unit including code that, when executed by the processing core, is operable to cause the network processor to perform actions comprising:
detecting a first condition;
identifying a first instance of a first interface suitable for handling the first condition;
selecting the first instance of the first interface from a plurality of instances of the first interface;
generating a code image that includes the first instance of the first interface; and
loading the code image into one or more of the microengines for execution.

27. A system as in claim 26, in which the memory unit further includes a linker, the linker being operable to interpret a switch statement and to remove unselected instances of an interface from the switch statement.

28. A system as in claim 26, in which the memory unit further includes an instance resolver, the instance resolver including the code for detecting a first condition and identifying a first instance of a first interface suitable for handling the first condition.
